(19) United States
(12) Patent Application Publication
(10) Pub. No.: US 2010/0303975 A1
(43) Pub. Date: Dec. 2, 2010

(54) Honey Replacement Syrup

(76) Inventor: Michael D. Bunch, Decatur, IL (US)

Correspondence Address: WILLIAMS, MORGAN & AMERSON, P.C., 10333 RICHMOND, SUITE 1100, HOUSTON, TX, 77042, US

(21) Appl. No.: 12/787,533

(22) Filed: May 26, 2010

Related U.S. Application Data
(60) Provisional application No. 61/181,383, filed on May 27, 2009.

(51) Int. Cl. A23L 1/08; A23L 1/09; A23L 1/29; A23L 2/60

(52) U.S. Cl. 426/253; 426/658; 426/590

(57) ABSTRACT

A composition comprising from about 55% d.s.b. to about 70% d.s.b fructose; and from about 9% d.s.b. to about 20% d.s.b. maltose. A method comprising mixing a first aqueous solution comprising from about 85% d.s.b. to about 95% d.s.b. fructose with a second aqueous solution comprising from about 35% d.s.b. to about 60% d.s.b maltose, to yield a third aqueous solution comprising from about 55% d.s.b. to about 70% d.s.b fructose and from about 9% d.s.b. to about 20% d.s.b. maltose. A method comprising adding 1 weight part of a composition comprising from about 55% d.s.b. to about 70% d.s.b fructose and from about 9% d.s.b. to about 20% d.s.b. maltose, to from about 0.1 weight parts to about 100 weight parts of a foodstuff.

This application claims priority from U.S. provisional patent application Ser. No. 61/181,383, filed on May 27, 2009, which is incorporated herein by reference.

### BACKGROUND OF THE INVENTION

The present invention relates to compositions that may be used as replacements for natural honey.

### SUMMARY OF THE INVENTION

In one embodiment, the present invention relates to a composition comprising from about 55% d.s.b. to about 70% d.s.b fructose; and from about 9% d.s.b. to about 20% d.s.b. maltose; wherein the composition has a total solids content from about 75 wt % to about 85 wt %.

In another embodiment, the present invention relates to a method comprising mixing a first aqueous solution comprising from about 85% d.s.b. to about 95% d.s.b. fructose with a second aqueous solution comprising from about 35% d.s.b. to about 60% d.s.b maltose, to yield a third aqueous solution comprising from about 55% d.s.b. to about 70% d.s.b fructose and from about 9% d.s.b. to about 20% d.s.b. maltose; wherein the third aqueous solution has a total solids content from about 75 wt % to about 85 wt %.

In one embodiment, the present invention relates to a method comprising adding 1 weight part of a composition comprising from about 55% d.s.b. to about 70% d.s.b fructose and from about 9% d.s.b. to about 20% d.s.b. maltose, wherein the composition has a total solids content from about 75 wt % to about 85 wt %, to from about 0.1 weight parts to about 100 weight parts of a foodstuff.

### DESCRIPTION OF ILLUSTRATIVE EMBODIMENTS

In one embodiment, the present invention relates to a composition comprising from about 55% d.s.b. to about 70% d.s.b fructose; and from about 9% d.s.b. to about 20% d.s.b. maltose; wherein the composition has a total solids content from about 75 wt % to about 85 wt %.

Herein, the term “% d.s.b.” refers to a percentage on a dry solids basis. Fructose and maltose from any sources can be used. In one embodiment, the fructose source is a greens from a fructose crystallization process.

Fructose crystallization processes are used to produce high purity and high solids fructose streams from grain milling plants, such as corn wet milling plants. Typically, a cooled and supersaturated aqueous solution comprising fructose is prepared, to which finely ground fructose crystals are added. The fructose crystals seed crystallization of much of the fructose in solution. Various process parameters, such as agitation and duration, can be adjusted to yield desired finished product size of the solid crystals of fructose.

The result of a fructose crystallization process is called a massequite, which comprises the mother liquor and solid crystals. The mother liquor contains fructose in aqueous solution. The mother liquor and solid crystals are separated from each other by appropriate treatment of the massequite, e.g. centrifugation. Typically, the solid crystals of fructose are washed with water to remove non-crystalline fructose. The mother liquor and the liquid from washing comprise what is known in the art as ‘greens,’ though they typically have a color closer to caramel or honey.

In one embodiment, the greens are a by-product of the production of a pure fructose product, such as Krystar® (Tate & Lyle, Decatur, Ill.).

In one embodiment, the greens have a maximum optical density of 0.378 at 560 nm and a cell thickness of 3.15 cm.

Any source of maltose can be used. In one embodiment, the maltose is from a high maltose corn syrup. In one embodiment, the high maltose corn syrup comprises about 43-50% d.s.b. maltose, about 7-12% d.s.b. dextrose, and a total solids content of about 80.5-81.5%.

In one embodiment, the high maltose corn syrup has a maximum optical density of 0.378 at 560 nm and a cell thickness of 3.15 cm. In a further embodiment, the high maltose corn syrup has a maximum optical density of 0.10 at 550 nm and a cell thickness of 3.15 cm.

In addition to fructose and maltose, the composition can further comprise additional compounds. It is desirable that all such compounds be suitable for human or animal consumption.

In one embodiment, the composition further comprises from about 1% d.s.b. to about 15% d.s.b. at least one monosaccharide other than fructose. An exemplary monosaccharide other than fructose is dextrose. In one embodiment, the source of dextrose is a high maltose syrup.

In embodiments wherein the composition comprises fructose, maltose, and dextrose in the amounts discussed above, the composition may be referred to as a “fructose, maltose, dextrose blend.”

In one embodiment, the composition further comprises from about 5% d.s.b. to about 20% d.s.b. at least one oligosaccharide comprising three or more monosaccharide units.

In one embodiment, the composition further comprises from about 0.001% d.s.b. to about 5% d.s.b., such as from about 0.01% d.s.b to about 5% d.s.b., of at least one polymer comprising at least one furan-containing unit selected from 2-furfuraldehyde (furfural) units, 5-hydroxymethyl-2 furfuraldehyde (HMF) units, and mixtures thereof. In one embodiment, the source of the at least one polymer comprising at least one furan-containing unit selected from furfural units, HMF units, and mixtures thereof is a greens from fructose crystallization.

In one embodiment, the composition further comprises monomers of furfural, HMF, or both.

In one embodiment, the composition further comprises from about 0.01% d.s.b. to about 1% d.s.b. of at least one floral flavor. A “floral flavor” is used herein to refer to a compound or a mixture of compounds that have a taste, aroma, or both which the person of ordinary skill in the art will recognize as being the taste, aroma, or both of a flower of a particular plant. In one embodiment, the floral flavor is a clover flavor. Other floral flavors can be used, such as acacia, alfalfa, avocado, basswood, blueberry, buckwheat, eucalyptus, fireweed, heather, lavender, leatherwood, linden, manuka, orange blossom, pumpkin blossom, red gum, rewarewa, pine tree, sourwood, sage, tawari, tupelo, and mixed floral (wildflower). Generally, the floral flavor is a flavor known or suitable as a component of natural honey.

The composition may comprise any one, two, or more of the above independently of any other one, two, or more of the above.

The composition also desirably does not contain certain other compounds. For example, in one embodiment, the composition does not comprise protein. “Protein” here refers to any oligo- or polypeptide comprising at least about 5 amino acid residues. By “does not comprise” is meant the composition comprises less than about 0.01% d.s.b. protein. In one embodiment, the composition comprises less than the detectable limit of protein. (The person of ordinary skill in the art will understand how to detect the amount of protein in the composition, whether the amount is below the detectable limit of the detection technique used, and the sensitivities of various detection techniques as a matter of routine experimentation).

In one embodiment, the composition does not comprise bee protein, by which is meant any protein synthesized by the metabolic processes of an insect of the genus Apis.

In another embodiment, the composition can comprise vegetable protein, by which is meant any protein synthesized by the metabolic processes of a member of kingdom Plantae.

Another compound that the composition desirably does not comprise is sucrose. By “does not comprise sucrose” is meant that the composition contains less than about 0.1% d.s.b. sucrose.

The composition may both not comprise protein and not comprise sucrose, or it may not comprise one or the other.

Depending on the intended use, in certain embodiments, the composition may comprise protein, sucrose, or both.

A composition according to one or more embodiments of the present invention can be suitable for a number of uses. We have found that the proportions of fructose and maltose set forth above generally provide an edible composition that has a sweetness and a mouthfeel comparable to that of natural honey. Such a composition can be packaged directly as a honey substitute or combined with natural honey as a honey extender.

At the present time, honey produced in North America is in short supply (est. 120 mM pounds/year) while demand remains strong (400-500 mM pounds/year). As a result, the price of North American honey has increased. Overseas honey may be imported, but is currently charged a heavy duty charged of $1.22/pound to compensate for so-called dumping. In addition, different foreign countries and suppliers may have less stringent standards for defining a product as “honey” than apply to North American and Western European governments and packagers and other commercial users of honey. For example, at least some shipments of honey from a particular foreign country to the United States were recently barred entry into the U.S. food supply for containing antibiotics which were fed to the bees that produced the honey, in contravention of United States standards regarding honey quality. Therefore, demand exists for materials that can replace honey in at least some uses.

In embodiments wherein the composition further comprises at least one polymer comprising at least one furan-containing unit selected from furfural units, HMF units, and mixtures thereof, the at least one polymer containing at least one furan-containing unit can impart both a caramel or honey color and a caramel, butter, bread, roasted, musty, coffee, or toasty flavor note to the composition, making it even more desirable as a honey substitute. The inclusion of at least one floral flavor can round out the flavor profile of the composition to even more closely resemble natural honey.

In one embodiment, the composition has a maximum optical density of 0.378 at 560 nm and a cell thickness of 3.15 cm. For example, this maximum optical density is expected for embodiments wherein the fructose source and the maltose source each have a maximum optical density of 0.378 at 560 nm and a cell thickness of 3.15 cm. In this embodiment, according to the USDA standards for honey color known to the person of ordinary skill in the art, the composition would be considered White. In a further embodiment, the composition has a maximum optical density of 0.189 at 560 nm and a cell thickness of 3.15 cm. According to the USDA standards, the composition would then be considered Extra White. In yet a further embodiment, the composition has a maximum optical density of 0.0945 at 560 nm and a cell thickness of 3.15 cm. According to the USDA standards, the composition would then be considered Water White.

A number of compositions of the present invention also have properties that may make them more favorable than natural honey for particular uses. For example, in embodiments wherein the composition has a relatively low amount of dextrose compared to natural honey (about 35-40% d.s.b), it is less likely to crystallize at room temperature or refrigerated temperature than is natural honey. A reduced likelihood of crystallization is also a property of compositions that do not comprise sucrose.

In any embodiment wherein the composition does not comprise animal protein, such as bee protein, the composition may be considered vegan. It should be noted that naturally-occurring honey typically comprises bee protein and is generally considered not vegan. The bee protein typically comprises a number of enzymes, including invertase, diastase (a.k.a. amylase), glucose oxidase, catalase, and acid phosphatase. In addition to rendering bee protein non-vegan, one or more of these enzymes, for example, diastase, can also degrade natural honey during storage and transport.

In another embodiment, the present invention relates to a method, comprising:

mixing a first aqueous solution comprising from about 85% d.s.b. to about 95% d.s.b. fructose with a second aqueous solution comprising from about 35% d.s.b. to about 60% d.s.b maltose, to yield a third aqueous solution comprising from about 55% d.s.b. to about 70% d.s.b fructose and from about 9% d.s.b. to about 20% d.s.b. maltose; and

adjusting the water content of the third aqueous solution, to yield a composition with a total solids content from about 75 wt % to about 85 wt %.

The first aqueous solution comprising from about 85% d.s.b. to about 95% d.s.b. fructose can have any particular total solids content. As discussed above, in one embodiment, the first aqueous solution is a greens from a fructose crystallization process. In one embodiment, the first aqueous solution has a total solids content from about 77% total solids to about 85% total solids.

The second aqueous solution comprising from about 35% d.s.b. to about 60% d.s.b maltose can have any particular total solids content. In one embodiment, the second aqueous solution has a total solids content of about 80% to about 85%, such as from about 80.5% to about 81.5%. In one particular embodiment, the second aqueous solution is NETO® 7350 corn syrup (Tate & Lyle, Decatur, Ill.).

The volume parts of the first aqueous solution and the second aqueous solution can be routinely selected based on the fructose and maltose contents and the total solids contents of the two solutions. In embodiments wherein the first aqueous solution is greens and the second aqueous solution is a high maltose syrup as described above, the range of volume parts for mixing can be from about 2:1 greens:high maltose syrup to about 4:1 greens:high maltose syrup.

In addition to fructose, the first aqueous solution can further comprise other compounds. In one embodiment, the first aqueous solution further comprises from about 0.001% d.s.b. to about 5% d.s.b. of at least one polymer comprising at least one furan-containing unit selected from furfural units, HMF units, and mixtures thereof. In a further embodiment, the first aqueous solution further comprises from about 0.01% d.s.b. to about 5% d.s.b. of the at least one polymer comprising at least one furan-containing unit selected from furfural units, HMF units, and mixtures thereof.

In addition to maltose, the second aqueous solution can further comprise other compounds. In one embodiment, the second aqueous solution further comprises from about 1% d.s.b. to about 30% d.s.b. at least one monosaccharide other than fructose. In one embodiment, the at least one monosaccharide other than fructose is dextrose.

In another embodiment, the second aqueous solution comprises from about 5% d.s.b. to about 40% d.s.b. at least one oligosaccharide comprising three or more monosaccharide units.

The term “mixing” comprises any comingling of the first aqueous solution and the second aqueous solution that yields an essentially homogeneous third aqueous solution. For example, the two solutions to be mixed can be simultaneously separately introduced into a tank or other vessel. For another example, one of the solutions to be mixed can be introduced into a vessel containing a defined volume of the other solution. The introduction of the solutions may be sufficient to comingle the two, or use of a mixing apparatus may be performed. Particular mixing techniques are known in the art of handling aqueous solutions comprising fructose or maltose and can be chosen as a routine matter by the person of ordinary skill in the art.

After mixing, the water content of the third aqueous solution can be adjusted by techniques known in the art. If the total solids content of the third aqueous solution is higher than the total solids content desired for the final composition, adjusting can comprise simple dilution with water. If the total solids content of the third aqueous solution is less than the total solids content desired for the final composition, adjusting can comprise evaporation, osmosis, or other techniques known to the person of ordinary skill in the art.

In addition to the steps discussed above, other steps can be performed depending on the desired use of the composition and other considerations. In one embodiment, the method further comprises decolorizing the greens before mixing. In one embodiment, decolorization is by carbon treating. A decolorized composition may be desirable in uses where honey flavor is desirable for the composition but honey color is irrelevant or undesirable.

In one embodiment, the method further comprises adding at least one floral flavor to the third aqueous solution or the composition.

In addition to the steps discussed above, the method can comprise additional steps either upstream, downstream, or both.

In one embodiment, the present invention relates to a method comprising adding 1 weight part of a composition comprising from about 55% d.s.b. to about 70% d.s.b fructose and from about 9% d.s.b. to about 20% d.s.b. maltose, wherein the composition has a total solids content from about 75 wt % to about 85 wt %, to from about 0.1 weight parts to about 100 weight parts of a foodstuff.

The composition has been discussed above and, in one embodiment, is produced by the method discussed above.

The foodstuff can be any edible or potable composition to which it is desirable to add the composition of the present invention. In one embodiment, the foodstuff is natural honey.

In another embodiment, the foodstuff is a beverage. Exemplary beverages include teas, water, fruit or vegetable juices, carbonated non-alcoholic beverages, non-carbonated alcoholic beverages, beers, meads, sweetened alcoholic beverages, and non-alcoholic mixers intended for mixing with alcohol, among others.

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### Example

Two compositions, A and B, were prepared by combining greens from one of two commercially-operating fructose crystallization processes with a commercially-available high maltose syrup. The greens of composition A came from a first plant in North America, the greens of composition B came from a second plant in North America, and the high maltose syrup (NETO® 7350, Tate & Lyle) came from a third plant in North America. All the high maltose syrup used came from a single lot. No further materials were added. The source materials were characterized as shown in Table I:

TABLE I

| | | | | | | | |
|---|---|---|---|---|---|---|---|
| DP1 | | | | | | HMF | |
| (dextrose) | DP2 | DP3 | DP4+ | Fructose | Furfural | ppm_as | Solids |
| %_dsb | %_dsb | %_dsb | %_dsb | %_dsb | ppm_as is | is | %_as is |

Greens of A

| | | | | | | | | |
|---|---|---|---|---|---|---|---|---|
| low | 5.11 | 1.02 | 0.38 | 0.31 | 90.5 | <0.05 | 203 | 80.94 |
| high | 6.91 | 1.39 | 0.54 | 0.48 | 92.75 | <0.05 | 339 | 83.24 |

Greens of B

| | | | | | | | | |
|---|---|---|---|---|---|---|---|---|
| low | 7.09 | 1.2 | 0.38 | 0.35 | 87.22 | <0.05 | 223 | 81.49 |
| high | 9.86 | 1.51 | 0.47 | 0.48 | 90.53 | <0.05 | 371 | 85.25 |

Neto 7350 spec

| | | | |
|---|---|---|---|
| low | 7 | 43 | 80.5 |
| high | 12 | 50 | 81.5 |

Theoretical 70% greens/30% Neto blend range
(low × low, high × high)

| | | | | | |
|---|---|---|---|---|---|
| low | 5.677 | 13.614 | 61.054 | 142.1 | 80.808 |
| high | 10.502 | 16.057 | 64.925 | 259.7 | 84.125 |

Solids content was determined as 1 - the water content, where the water content was determined by the Karl Fischer titration method.

The optical density (OD) of the greens of A and B were measured at 560 nm and a cell thickness of 2 cm, and an OD for a cell thickness of 3.15 cm was calculated from the measured data. The greens of A had an average OD_{560 nm, 3.15 cm, calc} of 0.315 (minimum 0.254, maximum 0.385) and the greens of B had an average OD_{560 nm, 3.15 cm, calc} of 0.222 (minimum 0.181, maximum 0.255).

The compositions were analyzed for monosaccharides other than fructose (DP1), disaccharides including maltose (DP2), trisaccharides (DP3), tetra- and higher saccharides (DP4+), fructose, and solids. The analysis is presented in the Table II:

TABLE II

| | DP1 | DP2 | DP3 | DP4+ | Fructose | Solids |
|---|---|---|---|---|---|---|
| Composition | %_dsb | %_dsb | %_dsb | %_dsb | %_dsb | %_as is |
| A | 9.55 | 15.15 | 6.44 | 8.05 | 60.81 | 81.72 |
| B | 7.46 | 14.12 | 6 | 7.44 | 64.98 | 81.16 |

The analysis also revealed that, within analytical error, the entire DP2 fraction of both compositions A and B was maltose.

Subjective inspection showed both compositions to each have a sweetness and color comparable to natural honey and a flavor similar to natural honey but lacking in floral notes. An objective measure of the color revealed an average OD_{560 nm, 3.15 cm, calc} of 0.057 for Composition A and an average OD_{560 nm, 3.15 cm, calc} of 0.052 for Composition B.

Though not analyzed, we expected the protein content of both compositions A and B to be very low. We added no protein, and in particular, no animal protein, to the compositions. Further, we expected any protein content of either composition A or B to be essentially all vegetable protein, specifically, corn protein. We expected any amounts of animal protein in either composition A or B to be trace amounts permissible under United States or any state laws and/or regulations promulgated by the Food and Drug Administration, the Department of Agriculture, or other relevant agencies.

All of the compositions and methods disclosed and claimed herein can be made and executed without undue experimentation in light of the present disclosure. While the compositions and methods of this invention have been described in terms of preferred embodiments, it will be apparent to those of skill in the art that variations may be applied to the compositions and methods and in the steps or in the sequence of steps of the methods described herein without departing from the concept, spirit and scope of the invention. More specifically, it will be apparent that certain agents which are chemically related may be substituted for the agents described herein while the same or similar results would be achieved. All such similar substitutes and modifications apparent to those skilled in the art are deemed to be within the spirit, scope and concept of the invention as defined by the appended claims.

What is claimed is:

1. A composition, comprising:
from about 55% d.s.b. to about 70% d.s.b fructose; and
from about 9% d.s.b. to about 20% d.s.b. maltose;
wherein the composition has a total solids content from about 75 wt % to about 85 wt %.

2. The composition of claim 1, further comprising:
from about 1% d.s.b. to about 15% d.s.b. at least one monosaccharide other than fructose.

3. The composition of claim 2, further comprising:
from about 5% d.s.b. to about 20% d.s.b. at least one oligosaccharide comprising three or more monosaccharide units.

4. The composition of claim 1, further comprising from about 0.1% d.s.b. to about 5% d.s.b. of at least one polymer comprising at least one furan-containing unit selected from furfural units, HMF units, and mixtures thereof.

5. The composition of claim 1, further comprising from about 0.01% d.s.b. to about 1% d.s.b. of at least one floral flavor.

6. The composition of claim 1, wherein the composition does not comprise protein.

7. The composition of claim 1, wherein the composition does not comprise sucrose.

8. A method, comprising:
mixing a first aqueous solution comprising from about 85% d.s.b. to about 95% d.s.b. fructose with a second aqueous solution comprising from about 35% d.s.b. to about 60% d.s.b maltose, to yield a third aqueous solution comprising from about 55% d.s.b. to about 70% d.s.b fructose and from about 9% d.s.b. to about 20% d.s.b. maltose; and
adjusting the water content of the third aqueous solution, to yield a composition with a total solids content from about 75 wt % to about 85 wt %.

9. The method of claim 8, wherein the first aqueous solution is a greens from a fructose crystallization process.

10. The method of claim 9, further comprising decolorizing the greens before mixing.

11. The method of claim 8, wherein the second aqueous solution comprises from about 1% d.s.b. to about 30% d.s.b. at least one monosaccharide other than fructose.

12. The method of claim 8, wherein the second aqueous solution comprises from about 5% d.s.b. to about 40% d.s.b. at least one oligosaccharide comprising three or more monosaccharide units.

13. The method of claim 8, further comprising adding at least one floral flavor to the third aqueous solution or the composition.

14. A method, comprising:
adding 1 weight part of a composition comprising from about 55% d.s.b. to about 70% d.s.b fructose and from about 9% d.s.b. to about 20% d.s.b. maltose, wherein the composition has a total solids content from about 75 wt % to about 85 wt %, to from about 0.1 weight parts to about 100 weight parts of a foodstuff.

15. The method of claim 14, wherein the foodstuff is natural honey.

16. The method of claim 14, wherein the foodstuff is a beverage.
